(19) United States
(12) Patent Application Publication
(10) Pub. No.: US 2015/0240656 A1
(43) Pub. Date: Aug. 27, 2015

(54) EXHAUST GAS TURBINE AND METHOD OF CONTROLLING THE TURBINE

(71) Applicant: IHI CHARGING SYSTEMS INTERNATIONAL GMBH, Heidelberg (DE)

(72) Inventors: Jan EHRHARD, Wiesloch (DE); Dietmar FILSINGER, Wiesloch (DE); Manfred GUTHOERLE, Neckarbischofsheim (DE); Peter FLEDERSBACHER, Stuttgart (DE)

(73) Assignee: IHI CHARGING SYSTEMS INTERNATIONAL GMBH, Heidelberg (DE)

(21) Appl. No.: 14/708,214

(22) Filed: May 9, 2015

Related U.S. Application Data
(63) Continuation-in-part of application No. PCT/EP2013/003725, filed on Dec. 10, 2013.

(30) Foreign Application Priority Data
Dec. 17, 2012 (DE) 10 2012 112 396.9

(51) Int. Cl. F01D 17/10; F02C 6/12; F02B 37/18

(52) U.S. Cl. CPC F01D 17/105; F02B 37/183; F02C 6/12; F05D 2220/40; F05D 2260/60

(57) ABSTRACT

In an exhaust gas turbine with a guide section for the exhaust gas turbine comprising a flow-through duct for conducting exhaust gas through the exhaust gas guide section, wherein the flow-through duct includes a wheel chamber in which a turbine wheel is rotatably supported and wherein, downstream of the wheel chamber, the flow-through duct has an outlet portion and upstream of the wheel chamber, the flow-through duct has an inlet portion with a bypass duct being formed in the exhaust gas guide section for by-passing the wheel chamber, the by-pass duct forms an annular opening adjacent the turbine wheel for directing by-pass exhaust gas into the exhaust gas outlet portion in an annular flow pattern along the outlet portion duct wall.

This is a Continuation-in-Part application of pending international patent application PCT/EP2013/003725 filed 2013 Dec. 10 and claiming the priority of German patent application 10 2012 112 396.9 filed 2012 Dec. 17.

### BACKGROUND OF THE INVENTION

The invention relates to an exhaust gas turbine with a turbine wheel arranged in a housing which includes a by-pass duct structure to permit the exhaust gas to by-pass the turbine wheel.

In the past, charging of internal combustion engines by means of an exhaust gas turbocharger was mainly used in connection with to Diesel engines. Otto engines are only rarely provided with a charging unit. The reason is that Diesel engine combustion may be considerably influenced by charging in respect to fuel consumption, while this is not the case with Otto engine combustion because of the limited range of the combustion air/ratio with which combustion can be obtained.

However, the present objective is to reduce a piston displacement of the combustion engines, in order to achieve among others future CO₂ target values. In order to be able to achieve corresponding power, even with a small piston displacement, today's combustion engines with Otto engine combustion are also charged. Because of the high specific engine power which is required even for a small engine, the requirements for modern charging systems, in particular for an exhaust gas turbocharger. are continuously increasing. In view of the increasing need for reduced piston displacement, the so-called engine downsizing, it is therefore important to ensure high charging degrees of the exhaust gas turbocharger with a simultaneous satisfactory instationary behavior.

One possibility of achieving the proper charging degree and thus turbine efficiency meeting the high power requirements is to bypass the turbine wheel at high speeds and/or high loads of the combustion engine. For this purpose, it is provided to position a bypass duct in an exhaust gas guide section of a turbine, in which the turbine wheel is rotatably accommodated. Exhaust gas guide sections comprising a bypass duct for bypassing a turbine wheel which is rotatably accommodated in a wheel chamber of the exhaust gas guide section of a turbine are known. The exhaust gas guide sections for turbines are designed to be direct exhaust gas to the turbine wheel and comprise a flow-through duct for conducting the exhaust gas to the turbine. The inlet flow duct is formed so as to include the wheel chamber in which the turbine wheel is rotatably accommodated. The turbine wheel has a wheel inlet and a wheel outlet with a turbine wheel outlet diameter. Downstream of the wheel chamber, the flow-through duct comprises an outlet portion and upstream of the wheel chamber an inlet portion. Upstream of the wheel chamber, a bypass duct is formed for bypassing the wheel chamber, and this bypass duct opens downstream of the wheel chamber into the outlet portion such that the opening of the by-pass duct provides an effective flow by-passing the wheel chamber.

Patent specification DE 196 51 498 C1, for example discloses an exhaust gas guide section which comprises an axial slide valve for adjusting the effective flow cross-section for a turbine wheel positioned in the wheel chamber, wherein the effective flow cross-section of a bypass duct can be closed or opened, respectively, by the axial side valve.

Another possibility for opening or closing a bypass duct is disclosed in patent specification EP 0 607 523 A2. The effective flow cross-section of the bypass duct is adjustable by means of a pivotable flap. Here, generally so-called waste gate turbines a affected wherein a so-called flow bleed—the flow which bypasses the turbine wheel by means of the bypass duct—may be adjusted via the flap valve. This possibility has proven itself and in particular under the very high exhaust gas temperatures in the Otto engine combustion and can be implemented comparatively cost-effectively.

The turbine efficiency which decreases corresponding to the bleed flows is generally disadvantageous, in particular in a waste gate turbine, which primarily at high bleed flows—with smaller combustion engines with. Otto engine combustion bleed flows up to 50% are not uncommon—negatively influences a positive charge changing process. From this originates a principal motivation to employ systems with so-called variable turbine geometry as they are already state of the art in Diesel engines. In view of the considerably higher exhaust gas temperatures which occur in the Otto engine combustion and the inherent challenges concerning function and costs these known systems, however, have serious limitations.

It is therefore the principal object of the present invention to provide a turbine with an exhaust gas guide section for the turbine, by means of which a high turbine efficiency can be achieved over a large flow rate range, while simultaneously ensuring the functionality of the turbine wherein, furthermore, a high turbine efficiency may be achieved.

### SUMMARY OF THE INVENTION

In an exhaust gas turbine with a guide section for the exhaust gas turbine comprising a flow-through duct for conducting exhaust gas through the exhaust gas guide section, wherein the flow-through duct includes a wheel chamber in which a turbine wheel is rotatably supported and wherein, downstream of the wheel chamber, the flow-through duct has an outlet portion and upstream of the wheel chamber, the flow-through duct has an inlet portion with a bypass duct being formed in the exhaust gas guide section for by-passing the wheel chamber, the by-pass duct forms an annular opening adjacent the turbine wheel for directing by-pass exhaust gas into the exhaust gas outlet portion in an annular flow pattern along the outlet portion duct wall.

An exhaust gas guide section is generally designed in such a manner that the expansion of a fluid flowing through the exhaust gas guide section starts from an inlet area and extends an outlet area. The turbine wheel located between the outlet area and the inlet area is thereby brought into a rotatory motion by the fluid. This rotatory motion may be utilized in various ways. A standard exhaust gas turbocharger to be employed e. g. for combustion engines is equipped with a turbine and a compressor in which a compressor wheel is positioned which is connected for rotation with the turbine wheel via a shaft. Upon initiating the rotatory motion of the turbine wheel, this rotatory motion is transferred to the compressor wheel so that the operation of the compressor, that is suction and compression generally of fresh air, can be performed.

For determining an efficiency of the turbine, in particular a pressure at the wheel inlet and a pressure at the wheel outlet are decisive in addition to a corresponding mass flow of the fluid flowing through the exhaust gas guide section. Because an expansion of the fluid in the turbine should have taken place, the pressure at the wheel inlet should be higher than the pressure at the wheel outlet. This is usually the case in particular at medium to high operating conditions of the turbine, i. e. at medium to high mass flows. The pressure gradient is the pressure difference between the pressure at the wheel inlet and the pressure at the wheel outlet, which has to be increased in order to achieve an efficiency as high as possible. The pressure of fluids as such is a combination of a static pressure and a dynamic pressure. It is principally safer and easier to influence the static pressure than the dynamic pressure.

The advantage of this inventive exhaust gas guide section is a specific reduction of the static pressure at the wheel outlet, so that the pressure at the wheel outlet combined with the static pressure and the dynamic pressure is reduced in order to maximize the pressure gradient at the turbine wheel. This means that an exhaust gas mass flow conducted through the bypass duct is not simply supplied into the outlet portion as usual, but that this exhaust gas mass flow is deliberately used to enhance the pressure gradient at the turbine wheel.

Another advantage of the invention is the potential reduction of the exhaust gas counter pressure of the combustion engine. When the static pressure at the wheel outlet is reduced by means of the invention, there is also the possibility to decrease the static pressure at the wheel inlet so that a so-called exhaust gas counter pressure of the combustion engine is also reduced. Thus, it becomes possible to achieve an improved charge cycle of the combustion engine, which again may result in fuel reduction and thus in a reduction of pollutant emissions.

A particularly high pressure reduction at the wheel outlet may be achieved if the opening is formed in a boundary area between the wheel chamber and the outlet area. In particular, a leading edge of the opening, which faces the turbine wheel, is positioned at a distance from an impeller blade trailing edge of the turbine wheel. Ideally, the distance is determined depending on a turbine wheel diameter at the wheel outlet, wherein an optimum distance ranges from 0 to 0.15*turbine wheel diameter at the wheel outlet.

In another embodiment of the inventive exhaust gas guide section, the flow cross-section of the opening is the smallest cross-section of the bypass duct. When the smallest flow cross-section of the bypass duct is located at the opening, a special ejector effect may be achieved. This means, as soon as the fluid from the bypass duct flows into the outlet area via the opening, a reduction of the static pressure at the wheel outlet may be achieved.

A further increase in pressure reduction at the wheel outlet may be achieved if the bypass duct is inclined at an angle relative to an axis of rotation of the turbine wheel. The bypass duct is to be formed in such a manner that the bypass duct is inclined toward the outlet area. That a duct axis of the bypass duct in the area of the opening should extend at an acute angle relative to the axis of rotation of the turbine wheel. Ideally, the angle of inclination ranges from 20° to 40°. Thereby an optimum ejector effect and thus a considerable pressure reduction at the wheel outlet may be achieved.

In order to obtain a large-area effective range of the ejector effect, the flow cross-section of the opening is advantageously formed annular in the exhaust gas guide section. This means that the flow cross-section is formed over the entire wheel circumference of the turbine wheel at the wheel outlet. An annular flow cross-section of the opening which is formed concentric to the axis of rotation of the turbine wheel is particularly advantageous.

In another advantageous embodiment of the inventive exhaust gas guide section, the outlet duct is formed diffusor-type or as a diffusor, respectively. This diffusor-type configuration enhances the ejector effect, so that an additional pressure reduction at the wheel outlet may be achieved.

In a further embodiment of the invention, the bypass duct comprises a control device for opening and closing the bypass duct, so that the fluid quantity flowing through the bypass duct can be controlled.

Advantageously, the control device is formed as a sleeve which is axially movable in the outlet portion. This means that the fluid quantity may be adjusted by means of the sleeve, and in addition the smallest flow cross-section which is positioned in the opening may be adjusted, so that an influence may be exerted on different operating points, i. e. different fluid quantities, such that, depending on the fluid quantity a correspondingly set pressure reduction at the wheel outlet is possible. The control device may alternatively be built as a rotary slide valve, which means that the axial slide valve is arranged in the exhaust gas guide section so as to be not only axially movable but also rotatable.

In an alternative embodiment of the inventive exhaust gas guide section, the control device is formed as a butterfly valve. This means that standard exhaust gas guide sections may be modified with standard butterfly valves, which implies that at the wheel outlet corresponding retrofitting measures of the bypass duct have to be taken. In a simple case, this may be done by retrofitting the exhaust gas guide section with a suitable shaped component, e. g. a sheet metal sleeve, so that in the area of the wheel outlet the smallest flow cross-section of the bypass duct is formed. Thus, also for a conventional exhaust gas guide section an increase of the efficiency may be easily achieved.

Another possibility to control the exhaust gas flow is to provide a so-called rotary valve. This means that a rotary valve is positioned in the bypass duct in lieu of a butterfly valve, which is rotatable about an axis of rotation which generally extends orthogonally to a duct axis of the bypass duct.

In particular with a control device in the form of an axial slide valve or a rotary slide valve, respectively, advantages regarding noise emission are achievable, because rattling, clattering or crackling has already been eliminated due to the structural design.

Further advantages, features and details of the invention will become more readily apparent from the following description of preferred exemplary embodiments with reference to the accompanying drawings. The features and feature combinations are not only applicable as described and shown in the drawings but also in other combinations or alone, without deviating from the scope of the invention.

### BRIEF DESCRIPTION OF THE DRAWINGS

FIG. 1 shows a longitudinal section through an inventive exhaust gas turbine guide section in a first exemplary embodiment; and

FIG. 2 shows a longitudinal section through an inventive exhaust gas turbine guide section in a second exemplary embodiment.

### DESCRIPTION OF PARTICULAR EMBODIMENTS

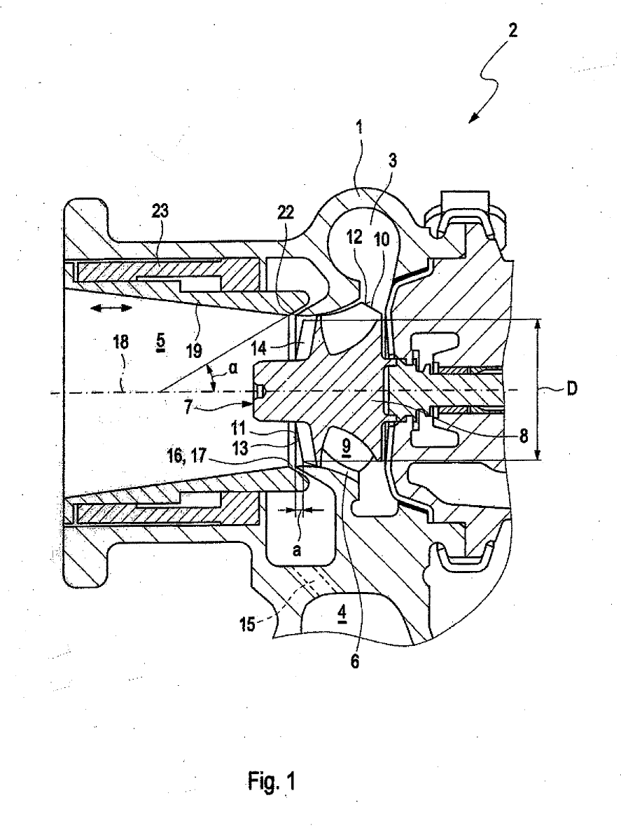

An inventive flow-through exhaust gas guide section 1 according to FIG. 1 of a turbine 2, in particular a turbine of an exhaust gas turbocharger, comprises a flow duct 3 for conducting the exhaust gas, in particular the exhaust gas of a combustion engine to a turbine wheel 7. The flow duct 3 comprises an inlet portion 4 through which the fluid flow enters the exhaust gas guide section 1 and an outlet portion 5 through which the fluid is discharged from the exhaust gas guide section 1. Between the inlet portion 4 and the outlet portion 5 a wheel chamber 6 is arranged in the exhaust gas guide section 1. The turbine wheel 7 is rotatably accommodated in the wheel chamber 6.

The turbine wheel 7 comprising a hub 8 and a plurality of impeller vanes 9 fixed at the hub has a wheel inlet 10 and a wheel outlet 11. The wheel inlet 10 is formed at an outermost impeller vane leading edge 12 of an impeller vane 9 and the wheel, outlet 11 is formed at an outermost impeller vane trailing edge 13 of the impeller vane 9. This means in other words that a first contact of the fluid flow with impeller vanes 9 is prevailing at the wheel inlet 10, while a last contact of the fluid flow with the impeller vanes 9 occurs at the wheel outlet 11.

Between two impeller vanes 9 each a flow duct 14 is formed for the fluid flow, wherein the fluid flow enters the flow duct 14 at the impeller vane leading edge 12 and is discharged at the impeller vane trailing edge 13 from the flow duct 14. The thermodynamic principle of the turbine 2, which may be mapped by means of the exhaust gas guide section 1, is the expansion of the fluid flow. This means that the fluid flow exhibits a higher pressure at the wheel inlet 10 than at the wheel outlet 11. During the operation of the turbine 2, a positive pressure gradient, a positive difference between the pressure at the wheel inlet 10 and the pressure at the wheel outlet 11, is ensured. The higher this positive pressure gradient is, the higher is the efficiency of the turbine 2. The maximization of this pressure gradient at given boundary conditions results in an increase of the turbine efficiency. Since, however, the inertia of the turbine wheel 7, which determines the acceleration behavior of the turbine 2 during operation of the turbine 2, interacts with the geometric dimension of the turbine wheel 7 in the operating behavior of the turbine 2, care must be taken not to design the turbine wheel 7 too large—because of the moment of inertia—but, however, not too small either—because of its flow-through capacity. For optimizing the acceleration behavior, a bypass duct 15 is provided for bypassing the turbine wheel 7 in the exhaust gas guide section 1. This means, this bypass duct 15 is opened, as soon as the fluid flow has reached a certain quantity which could negatively influence the pressure gradient. In other words, as soon as the fluid flow can no longer flow through the turbine wheel 7 unhindered, and thus choking of the turbine 2 occurs, the bypass duct 15 is opened so that the fluid flow may partially flow around or bypass, respectively, the turbine wheel 7.

For increasing the pressure at the wheel outlet 11, an opening 16 of the bypass duct 15 is positioned in the area of the wheel outlet 11 so that the fluid flowing through the bypass duct 15 may enter the outlet portion 5 of the flow-through duct 3. Thus, the opening 16 is formed in a boundary area of the wheel chamber 6 and of the outlet portion 5, i, e. in an area of the flow-through duct in which the wheel chamber 6 adjoins the outlet portion 5.

This means in other words that a leading edge 22 of the bypass duct 15, which faces the wheel inlet 10, is positioned at the wheel outlet 11 or at the impeller vane trailing edge 13, respectively. Ideally, there is a distance a between the leading edge 22 and the impeller vane trailing edge 13 ranges between 0<a<0.15*D, wherein D is a turbine wheel diameter at the impeller vane trailing edge 13.

The bypass duct 15 exhibits the smallest flow cross-section 17 at the opening 16, so that by means of this smallest flow cross-section 17 a so-called ejector effect may be achieved. The bypass duct 15 is positioned in the exhaust gas guide section 1 and comprises an angle of inclination a in particular at the opening 16 relative to an axis of rotation 18 of the turbine wheel 7. In this exemplary embodiment, the angle of inclination a has a value of 30°. In order to achieve an increase of the positive pressure gradient, i. e. to reduce the static pressure at the wheel outlet 11, the angle of inclination α should assume a value ranging between 20°<α<40°.

FIG. 1 shows a first exemplary embodiment of the inventive exhaust gas guide section 1, wherein an axial slide valve 19 is provided in the outlet portion 5 for changing the flow quantity around the turbine wheel 7. This axial slide valve 19 is formed as an axially movable sleeve. The axial slide valve 19 is movable in the exhaust gas guide section 1 by means of a guide element 23 in a controlled manner. Ideally, the smallest flow cross-section 17 is adjustable by means of the axial slide valve 19 and can thus control the fluid quantity flowing through the bypass duct 15. Of course, care must be taken that the flow cross-section 17 of the opening 16 is kept the smallest flow cross-section of the bypass duct 15, in spite of its adjustability. In other words, when adjusting the axial slide valve 19, care must be taken that the flow cross-section 17 of the opening 16 does not become larger than the flow cross-section of the bypass duct 15 at any other place of the bypass duct 15.

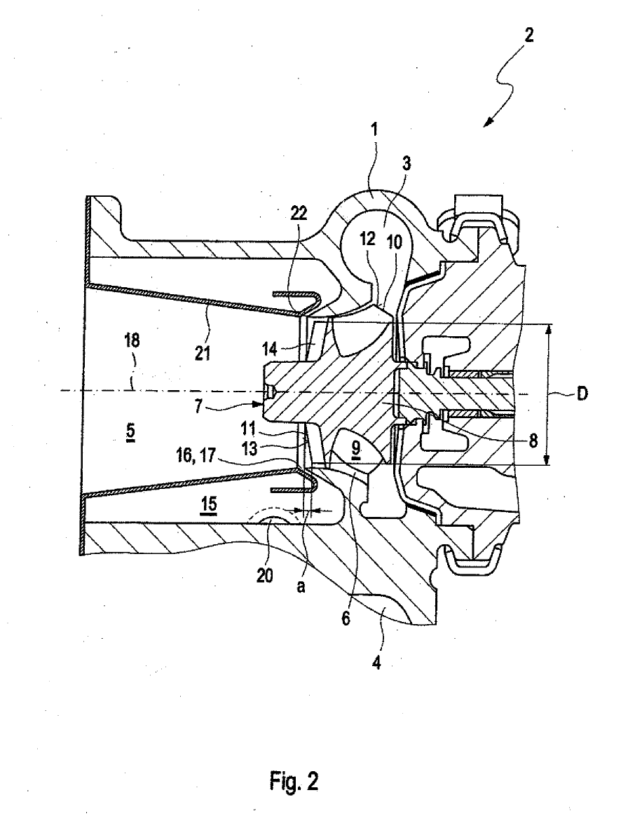

FIG. 2 shows another exemplary embodiment of a turbine with the inventive exhaust gas guide section 1. Here, opening and closing of the bypass duct are realized by means of a so-called butterfly valve 20. This butterfly valve 20 is provided in the bypass duct 15 regardless of a certain position. A sleeve-shaped contour element 21 is provided by means of which the annular flow cross-section 17 of the opening 16 is provided. This contour element 21 may be a plain sheet metal cover. The contour element 21 is to be positioned in such a manner that the smallest flow cross-section 17 is located in the opening 16 which is to be arranged in the area of the wheel outlet 11. Because the flow cross-section 17 of the opening 16 in this exemplary embodiment the opening is not adjustable. The annular flow cross-section 17 is dimensioned just large enough to achieve a desired characteristic flow rate for a combustion engine which is connected with the exhaust gas turbocharger at a completely opened flow cross-section of the flow-through duct 3 by means of the butterfly valve 20. The ejector effect is thereby reduced to an operation at bleed flow rates, i. e. large quantities of the flowing fluid bypass the turbine wheel 7 through the bypass duct 15.

Both in the first exemplary embodiment and in the second exemplary embodiment, the outlet portion 5 of the exhaust gas guide section 1 is in the form of a diffusor, i. e. the duct flow cross-section 21 of the outlet portion 5 continuously increases starting from the wheel outlet 11 to the end of the flow-through duct 3. By means of this diffusor-type design of the outlet portion 5 the ejector effect at the wheel outlet 11 may be considerably enhanced with the result of a reduction of the static pressure at the wheel outlet 11 and in the outlet portion 5, respectively.

What is claimed is:

1. An exhaust gas turbine with a flow guide section (1), comprising a flow-through duct (3) which includes a turbine wheel chamber (6) in which a turbine wheel (7) is rotatably supported, an inlet section (4) upstream of the turbine wheel chamber (6) and an exhaust section (5) at an exit end (11) of the turbine wheel chamber with a conical sleeve (19) movably disposed in the exhaust section (5) and forming at its front end adjacent the turbine wheel exit end (11), a bypass duct (15) extending from the inlet section (4) to an annular bypass flow opening (16) for directing by-pass exhaust gas into the exhaust section (5) downstream of the wheel chamber (6), the by-pass flow opening (16) with a flow cross-section (17) forming a by-pass passage into the area of the exit end (11) into the exhaust section (5).

2. The exhaust gas guide section according to claim 1, wherein the opening (16) is formed in a boundary area between the wheel chamber (6) and the outlet portion (5).

3. The exhaust gas guide section according to claim 1, wherein a leading edge (22) of the by-pass flow opening (16) is formed facing the turbine wheel (7), which is positioned at a distance (a) from an impeller vane trailing edge (13) of the turbine wheel (7), the distance (a) ranging from 0 to 0.15*D, wherein D is a turbine wheel diameter at the wheel outlet (11) of the turbine wheel (7).

4. The exhaust gas guide section according to one of claims 1, wherein the flow cross-section (17) of the by-pass flow opening (16) is a smallest cross-section of the bypass duct (15).

5. The exhaust gas guide section according to claim 1, wherein the bypass duct (15) exhibits an angle of inclination (α) at the by-pass flow opening (16) relative to an axis of rotation (18) of the turbine wheel (7), wherein the angle of inclination (α) is between 20 and 40°.

6. The exhaust gas guide section according to claim wherein the by-pass flow opening (16) extends into the outlet portion (5) annularly around the turbine wheel (7) at an angle with respect to an axis (18) of the turbine wheel enhancing the exhaust gas flow out of the turbine thereby reducing the exhaust gas pressure at the turbine wheel outlet end.

7. The exhaust gas guide section according to claim 6, wherein the by-pass flow opening (16) is concentric with the axis (18) of the turbine wheel (7).

8. The exhaust gas guide section according to claim 1, wherein the outlet portion (5) is in the form of a diffuser structure.

9. The exhaust gas guide section according to claim 1, wherein the bypass duct (15) comprises a control device (19, 20) for opening and closing of the bypass duct (15

10. The exhaust gas guide section according to claim 9, wherein the control device (9) is in the form of a sleeve (21) which is axially movably disposed in the outlet portion (5) for adjusting the annular opening (16).

11. The exhaust gas guide section according to claim 9, wherein the bypass exhaust gas is admitted to the bypass duct (15) by a control device (20) in the form of a butterfly valve.

12. The exhaust gas guide section according to claim 9, wherein the control device (20) is in the form of a rotary slide valve.

13. The exhaust gas guide section according to claim 6, wherein the annular inlet opening (16) forming the inlet passage extends at an angle of 30° to 50° with respect the axis (18) of the turbine wheel (7).
